(19) United States
(12) Patent Application Publication
(10) Pub. No.: US 2008/0029973 A1
(43) Pub. Date: Feb. 7, 2008

(54) Hydraulic Seal Device With A Sleeve

(76) Inventor: Alfons Knapp, Biberach (DE)

Correspondence Address: BAKER & DANIELS LLP, 300 NORTH MERIDIAN STREET, SUITE 2700, INDIANAPOLIS, IN, 46204, US

(21) Appl. No.: 11/587,013

(22) PCT Filed: Apr. 22, 2005
(86) PCT No.: PCT/IB05/02364

§ 371 Date: Jun. 18, 2007

(30) Foreign Application Priority Data
Apr. 22, 2004 (IT) TO2004A000249

(51) Int. Cl. F16J 15/06; F16J 15/10; F16J 15/34

(52) U.S. Cl. 277/650; 277/387

(57) ABSTRACT

A seal device to be used to establish hydraulic static or dynamic seal between two conduction tubes (A and B) through which fluids are to be transported; it is equipped with a sleeve made of elastic material fitted in an appropriate containment seating depression; the entire device presents a section that narrows in size gradually from the outer rim line (2) toward the inner depth (3). The joint holding sleeve can present a radial, external cylindrical surface (5) and can even be eventually a commercial type joint sleeve; or it can be of an external radial surface that narrows axially from the extremity of the joint toward the corresponding internal axial extremity. Both the holding seat and the radial external surface (5) of the sleeve can have rectilinear or slightly curved, concave or convex generatrixes. The external radial surface (5) of the sleeve can present some retracted portions (8, 10, 11) that eventually may enclose air or lubricants and may be joined one to the other by ribbing (12) that extends in an axial direction.

### BACKGROUND AND SUMMARY OF THE INVENTION

The object of the present invention is a hydraulic mechanical seal made up of the following components: a joint holding sleeve and its apposite containment seating which is meant to establish a static or dynamic hydraulic hold between two components or tubes through which fluids must be conducted.

In the hydraulic joint tube packing devices with joint holding sleeves known so far, a gasket made of elastic material is presently being used; it normally is made up of a tubular joined cylindrical part and a fitting whose opening is of a diameter that is smaller than the inside diameter of the tubular part so as to establish around the opening an internal ring-like crown. The tubular cylindrical part is packed into its cylindrical container seat which is represented by the first of the two joined bodies between which one needs to establish a holding as the bottom piece is elastically pushed against the other component part. In the absence of a hydraulic pressure, the elastic force that the gasket must generate against the second body in question is generated by a spring inserted on the inside of the tubing joint sleeve and agent between the bottom seating of the first tube and the ring crown of the bottom of the gasket. When the system then incurs internal pressure, the difference between the containment seat and the section of the opening of the bottom heel piece generates an additional force applied to the gasket thus facilitating its hold toward the second body.

These holding devices are widely used by virtue of their effectiveness, but they do present a number of inconveniences. When the two holding components in which the gasket is operating shift in any way, the latter tends to be dragged and can risk being damaged in as much as its hold against the containment seat is not sufficiently capable of holding it in place. The holding capacity can thus be weakened causing leaks that lead to the corroding of the seat of the gasket thus causing it to loose holding power. In some instances, the gasket can even be dragged out of its seating and be leaked through its component parts. The tubular part of the gasket cannot have a large dimension since you also need sufficient room for the spring, a factor that makes the gasket even more subject to undergo deformations. In addition, the presence of the spring disturbs the flow that runs through the gasket thus introducing some resistance to the free flow of fluids and causing even noises. Even the need to install the gasket together with the pertinent spring contributes to the difficulties of mounting which thus cannot be carried out in any instrumental manner. Finally, an exact calibration of the spring is very difficult; that means that, in order to be sure it works properly, one is forced to use by far a stronger spring that necessary something that will cause an increase in resistance to the movement in the case of the dynamic holding device.

We have tried to put an end to these inconveniences by substituting the spring with appropriate extremities to the inner part of the gasket, strategically set up to press elastically against the bottom of the seat of containment; but the results have not been satisfactory due to the impossibility of obtaining with any degree of certainty any appropriate and adequate solicitation of the gasket.

The purpose of the present invention is eliminating the various inconveniences that have been noted in the joint hydraulic sealing devices presently known by offering the possibility of assigning to those devices some additional useful functions. More specifically, one of the aims is to insure that the gasket adhere more efficiently to its containment seat in order to avoid any tendency to being damaged by deformation. Another aim is allowing for the elimination of the spring and thus all the inconveniences resulting from such removal even as we insure that the gasket be sufficiently stimulated and facilitating the mounting of the device that can thus be used in an appropriate instrumental manner. Another aim has to do with allowing the on-demand substantial increase of the thickness and thus the resistance of the gasket. In some particular types of models, one of the aims is enabling the device to have the capacity of varying its pressure and thus reduce the relative noises that are generated.

In a holding seal device that entails an elastic material joint and a containment seat for this same joint extending between the mouth and the bottom, the principal aim of the invention is reached by the fact that in operative conditions the containment seat presents a transversal section that narrows gradually from the mouth toward the inner bottom at least at some appropriate levels lower than the transversal section presented by the gasket at the same levels.

Thanks to this characteristic, it follows that, in operative conditions, the gasket inserted in the containment seat receives, at least at some levels, a radial compression force that reduces its transversal section. Due to the inclination of the wall of the seating resulting from the reduction of its transversal section from the mouth toward the bottom, this principally radial force presents also an axial component that turns toward the opening of the seating that tends to push the gasket out of its containment seat. Thus it is possible, by choosing the appropriate dimensions and the conformation of the parts and the material that makes up the gasket, to insure that the axial component of the force be sufficient to replace the action of the spring usually employed for that purpose and can now be omitted. What follows is that the mounting is greatly facilitated by the fact that the gasket becomes the only thing that has to be introduced in the containment seating which means that the mounting can now be easily achieved in an instrumental manner. You no longer have to bother with having to insert the spring in a flow and you no longer have the problem of the noise. The radial gasket compressed toward the interior adheres effectively to the containment seating wall and is thus solidly held avoiding any tendency to come deformed or to be pushed out of its seating. In addition, since it is no longer necessary to reserve additional space inside the gasket for the spring, the wall of the gasket can be constructed with greater thickness than usual so as to confer to the gasket itself greater hardness. That means also that you can now also freely choose the internal shape of the gasket which can now be made so as to facilitate even more the passage of fluids.

The seal tubing joint holding sleeve used in the mechanical holding device in accordance to the invention can have a cylindrical radial external surface. In this case, and if the organic characteristics of the seal tubing gaskets already known are considered sufficient, it is possible to use in a holding device that conforms to the invention, the commercially available gaskets with ample economic advantages through savings. These commercial gaskets are to be used with a spring, but now they can also be used without the spring.

Nonetheless, the joint holding sleeve gasket used in the seal holding device that conforms to the invention can present a radial external surface that, just as it happens in the case of the containment seat, reduces in size from the external axial end of the gasket toward the internal axial end. Even in this instance, it is possible to obtain a useful axial component of the force applied to the gasket in the operative conditions as long as the conditions mentioned above are met and as long as, in it operative conditions, the transversal section of the containment seating is, at least in some levels, lower than the transversal section presented by the joint holding sleeve at the same level.

The surface of the containment seating can have rectilinear generatrixes and thus have the configuration of a cone trunk, or it can have generatrixes that are slightly curved, concave or convex oriented toward the inside of the seating.

Analogously, the external radial surface of the gasket can have rectilinear generatrixes and thus have the shape of a cylindrical configuration or the configuration of a truncated cone; it can also have slightly curved, concave or convex generatrixes directed toward the exterior.

The radial external surface of the gasket can in addition present some retracted sections in order to reduce its attrition toward the containment seating. These retracted portions do no compromise the useful adherence of the gasket to the wall of the containment seating as long as the adherence is at least insured to be at levels close to the extremities of the gaskets.

These retracted portions of the external radial surface of the gasket can also be quite notable in size. In such instances, they determine spaces that can hold a certain amount of air, air that can confer to the gasket important anti-noise properties as it absorbs the small variations in the pressure that can cause noise. In addition, these spaces created by the retracted portions of the external surface of the gasket may contain small quantities of grease or other lubrication that will facilitate the sliding of the radial external surface of the gasket over the walls of the containment seating.

In those instances in which the retracted portions of the external radial surface of the gasket are quite notable, it may be advantageous to join them together by means of axially directed extensions.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 illustrates the transversal section of a known holding device with a joint holding sleeve gasket;

FIG. 2 illustrates the joint holding sleeve gasket and the corresponding spring that are part of the holding device in accordance with FIG. 1;

FIG. 3 illustrates a transversal section of the holding device in conformity with an illustrative embodiment of the invention at the initial phase of mounting;

FIG. 4 analogously illustrates the holding device of FIG. 3 at an intermediate stage of mounting;

FIG. 5 similarly illustrates the holding device of FIG. 3 at the final operative stage;

FIG. 6 illustrates a possible modification that can be made to the joint holding sleeve gasket;

FIG. 7 illustrates the axial section of a commercial joint holding sleeve gasket which can be used in the invention as a holding device;

FIGS. 8 to 10 illustrate modifications that can be made to the joint holding sleeve gasket; and

FIG. 11 illustrates in a transversal section relative to the axis of the gasket equipped with axially directed extensions.

### DETAILED DESCRIPTION OF THE DRAWINGS

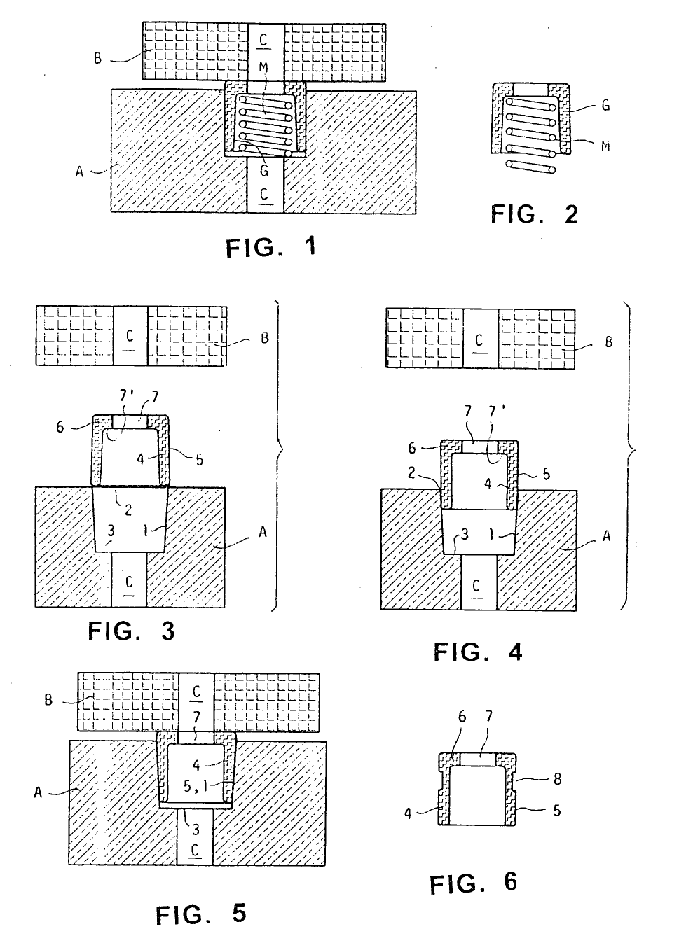

FIGS. 1 and 2 represent a seal device that does not have a joint holding sleeve. In FIG. 1 and in the following FIGS. 3 to 5, the letter A indicates a first organ or component for which an hydraulic holding has to be established with a cooperating second organ or component indicated by B both fitting around C, the area through which a flow of fluids must flow. The organs A and B can be set to be immobile one over the other or one of the two can be dedicated to movements connecting it to the other organ. These corresponding possibilities of movement or not determine whether the holding carried out by the seal shall be static or dynamic.

In FIGS. 1 and 2, the letter G indicates a joint holding sleeve gasket of the already known type which entails a tubular cylindrical form inserted in a seat that is similarly cylindrical in organ A and a part of the heel destined to be pushed against the surface of organ B and is equipped with an opening corresponding to passage C where the flow of fluid will take place. The holding of the gasket G relative to the seat that contains it is only the result of the elasticity of the gasket and the force with which the gasket presses elastically against the wall of the seat is necessarily weak or it would not be possible to insert the gasket in the seat. It follows that a certain degree of deformation is quite likely followed by eventual leaks of the gasket. In addition, the force with which the gasket G must be pushed against organ B must be exercised by a spring M contained inside the gasket G. Thus it is the G and M combination of FIG. 2 that must be inserted in the containment seat and thus greatly obstruct an instrumental introduction operation. It is also clear that spring M inside the gasket G obstructs the flow of fluids that runs through the passage C and causes turbulence and thus even noise.

In the invention application, as is made clear in FIG. 3, the containment seat for the present gasket presents a wall 1 that extends from an opening or mouth 2 to a heel 3. This wall 1 appears inclined because the seat is conformed in such a way as to present a transversal section that gradually narrows from opening 2 toward the heel 3. In this instance, the wall 1 presents a rectilinear generatrix so that its shape is that of a truncated cone.

In one example, the gasket employed is the commercial type, meaning that it is the same gasket G of FIGS. 1 and 2. It presents a tubular part 4 with an external radial surface 5 and a bottom heel 6 in which there appears an opening 7. Since opening 7 has a smaller section of the internal tubular part 4, a ring-like surface 7′ is present around the opening 7 and it is the one against which spring M acts in the known device.

Gasket 4-7 is thus placed against the opening 2 of the containment seat (FIG. 3) and is then pushed toward the inner part (FIG. 4). This operation is easy and can be effected instrumentally thanks to the fact that in the illustrative embodiment device, spring M of the previously known device is no longer present. As the gasket 4-7 is pushed to the internal part of the containment seat, it engages sections of the external wall 1 of the seat that become gradually smaller so that a growing radial force directed toward the center is applied to the part 4 of the gasket and causes its tightening. Due to the fact that the wall 1 presents an inclination, the force applied to part 4 of the gasket presents a larger component directed circularly toward the center but presents also an axial component directed toward the mouth 2 which pushes the gasket toward the outer part. This axial component of the force is thus analogous to the force which in the known device is exercised by the spring M. By appropriately choosing the inclination of wall 1 in consideration of the elastic reaction and of the attrition coefficient of the material that makes up the gasket, it is possible to obtain an axial force component that, in the operative configuration of the device (FIG. 5), that is to say when the second organ B is placed against the gasket, it becomes sufficient to replace the space of the missing spring M.

In this condition, the gasket becomes strictly adhering to the wall 1 of the seat and is efficiently held by it thus insuring that its deformation is surely avoided. In addition, even by using, as we are in this example, a commercial gasket, we note how the absence of the spring makes the flow of fluids much more fluid.

You can see from FIG. 6 that in the external surface 5 of part 4 of the gasket you can spot a withdrawn portion or retraction 8 which limits the contact surface with the containment seat and thus reduces attrition.

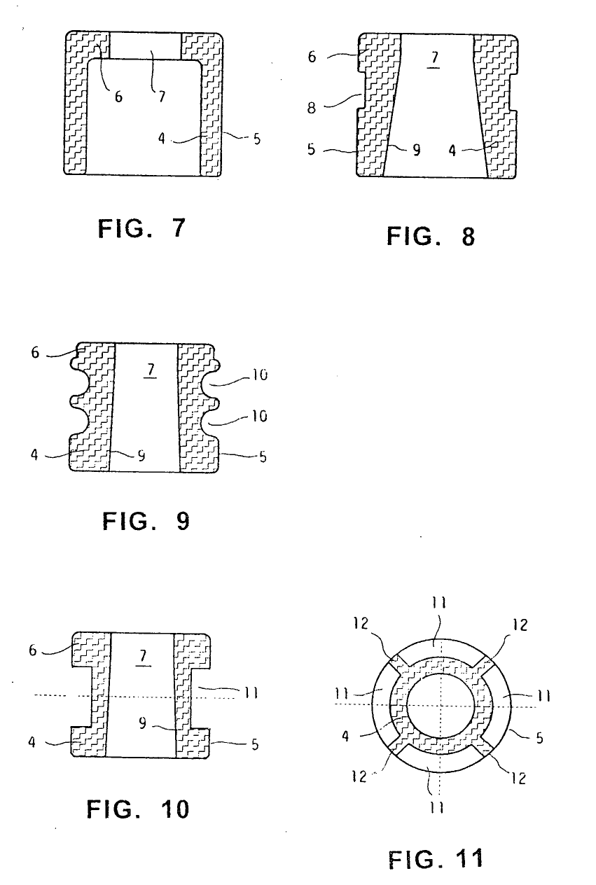

The commercial type gasket described, and represented in FIG. 7 can be adopted to achieve greater economic savings but the application of the invention makes it possible to adopt more favorable configurations for the gasket.

As FIG. 8 shows, since one no longer needs to contemplate any inside space for the spring, wall 4 of the gasket can be selected as notably thick so as to enhance its resistance and stability. In addition, the internal surface 9 of wall 4 can be presented narrowed at its axial internal end (lower part of the drawing) of the gasket up to the opening 7 situated at the external axial end (in the upper part of the drawing) of the gasket. What follows is a internal passage configuration that is much more conducive to an easy flow of fluids.

As FIG. 9 shows, in the external surface 5 of the wall 4, a number of retractions 10 of the gasket can be seen all of varying considerable capacity which trap a certain amount of air, air that confers to the gasket the capacity to absorb some variations of pressure, pressures that normally produce noises.

Similarly, a single retraction 11 of larger dimensions can be seen according to FIG. 10. In the cases in which the retracted portion 11 (or the overall retractions of 12) should weaken excessively the gasket, or should obstruct its introduction in the containment seat, it is possible to see that the gasket is strengthened by the ribbings 12 running along the axial line as FIG. 11 shows.

It must be understood that the invention is not limited to only those forms of realization described and illustrated in the above examples. Several possible modifications have been mentioned in the course of the description and others are possible within the range of what any technician in this sector can bring about. These and other modifications, as we as any substitution with similar technicians can be added to what has been described and illustrated without departing from the range of the invention and from the import of the present patent.

1. A seal device configured to establish at least one of a static and dynamic hydraulic hold between two organs through which a flow of fluids is to be conducted equipped with a joint holding sleeve made of elastic material and its apposite containment seat; the sleeve extends within one of said two organs between the mouth and the inside; it is characterized by the fact that said containment seat presents a section that narrows gradually from the opening toward the inner heel remaining, at least at some levels, in operative conditions smaller than the section presented by the gasket at the same levels.

2. A seal device in accordance with claim 1 characterized by the fact that said joint sleeve gasket presents a cylindrical external radial surface.

3. A seal device in accordance with claim 2 characterized by the fact that said joint sleeved gasket is a commercial type joint sleeved gasket.

4. A seal device in accordance with claim 1 characterized by the fact that said joint sleeved gasket presents an external radial surface that narrows along its external axial extremity of the gasket toward the internal axial end.

5. A seal device in accordance with claim 1 characterized by the fact that said containment seat presents a surface that is equipped with rectilinear generatrixes and thus has a truncated cone configuration.

6. A seal device in accordance with claim 1 characterized by the fact that the containment seat presents a surface that has generatrixes that are slightly curved, both in a concave and convex direction toward the inner part of the seat.

7. A seal device in accordance with claim 1 characterized by the fact that said gasket presents an external radial surface with rectilinear generatrixes and has thus the configuration of a cylinder or of a truncated cone.

8. A seal device in accordance with claim 1 characterized by the fact that said gasket presents an external radial surface with generatrixes that are slightly curved, concave or convex toward the outside.

9. A seal device in accordance with claim 1 characterized by the fact that said external radial surface of the gasket presents a number of retractions.

10. A seal device in accordance with claim 9 characterized by the fact that said retractions of the external radial surface of the gasket determine some spaces that enclose a certain amount of air thus conferring to the gasket anti-noise properties.

11. A seal device in accordance with claim 9 characterized by the fact the said retractions of the external radial surface of the gasket determine a number of spaces containing small quantities of grease or other similar lubricant.

12. A seal device in accordance with claim 9 characterized by the fact that said retractions of the external radial surface of the gasket are joined together by ribbings that extend in a radial direction.

13. A seal device in accordance with claim 1 characterized by the fact that the internal radial surface of the gasket is shaped in such a manner as to favor and facilitate the flow of fluids.

14. (canceled)

15. A seal device configured to provide a fluid seal between a first component and a second component, the seal device comprising:
a containment seat formed within the first component and including a wall defining an opening;
a gasket extending within the opening of the containment seat, the gasket including a tubular part having an external surface and configured to provide fluid flow between the first component and the second component; and
wherein the wall of the containment seat is angled relative to the external surface of the gasket for providing an axial force biasing the gasket away from the first component and toward the second component.

16. The seal device of claim 15, wherein at least one of the containment seat and the gasket has a frusto-conical cross-section.

17. The seal device of claim 15, wherein the containment seat has a cross-section that narrows gradually from the opening into the second component, and the gasket has a cross-section larger than at least a portion of the cross-section of the seat.

18. The seal device of claim 15, wherein the external surface of the gasket is cylindrical.

19. The seal device of claim 15, wherein the external surface of the gasket narrows along its axis in a direction from the first component to the second component.

20. The seal device of claim 15, wherein the wall of the containment seat includes a surface having a truncated cone configuration defined by at least one rectilinear generatrix.

21. The seal device of claim 15, wherein the wall of the containment seat includes a surface defined by at least one generatrix having a curvature, both in a concave and convex direction toward an inner part of the seat.

22. The seal device of claim 15, wherein the external surface of the gasket has a truncated cone configuration defined by at least one rectilinear generatrix.

23. The seal device of claim 15, wherein the external surface of the gasket is defined by at least one generatrix having a curvature.

24. The seal device of claim 15, wherein the external surface of the gasket includes a plurality of retractions.

25. The seal device of claim 24, wherein the plurality of retractions define spaces configured to enclose air thereby preventing noise.

26. The seal device of claim 24, wherein the plurality of retractions define spaces configured to contain a lubricant.

27. The seal device of claim 24, further comprising ribbings extending in a radial direction and connecting the plurality of retractions.

28. A seal device configured to extend between a first component and a second component, the seal device comprising:
a containment seat supported by the first component and including a wall defining an opening, the wall having a frusto-conical portion;
a gasket extending within the opening of the containment seat, the gasket including a tubular part having an external surface; and
wherein the frusto-conical portion of the wall of the containment seat is configured to provide an axial force biasing the gasket toward the second component and a radial force biasing the gasket toward the center axis of the opening.

29. The seal device of claim 28, wherein the external surface of the gasket is cylindrical.

30. The seal device of claim 28, wherein the external surface of the gasket is frusto-conical.

31. The seal device of claim 28, wherein the external surface of the gasket includes a plurality of retractions.

32. The seal device of claim 31, wherein the plurality of retractions define spaces configured to enclose air thereby reducing noise.

33. The seal device of claim 31, wherein the plurality of retractions define spaces configured to contain a lubricant.

34. The seal device of claim 31, further comprising ribbings extending in a radial direction and connecting the plurality of retractions.
